(19) United States
(12) Patent Application Publication
(10) Pub. No.: US 2018/0236933 A1
(43) Pub. Date: Aug. 23, 2018

(54) BRAKING INTENSITY INDICATION SYSTEM

(71) Applicant: Aaron Pontsler, Woodlawn, TN (US)

(72) Inventor: Aaron Pontsler, Woodlawn, TN (US)

(21) Appl. No.: 15/354,165

(22) Filed: Nov. 17, 2016

(51) Int. Cl. B60Q 1/44; B60T 7/04

(52) U.S. Cl. CPC B60Q 1/444; B60T 7/042

(57) ABSTRACT

The braking intensity indication system for indicating a force applied on a brake pedal of a vehicle comprises a sensor, a control unit, and an array of light sources. The sensor is mounted on the brake pedal for generating sensor data variables based on the force exerted on the brake pedal. The control unit receives the generated sensor data variables from the sensor. The control unit is configured to analyze the received sensor data variables. The array of light sources is in electrical communication with the control unit. The control unit of the braking intensity indication system actuates one or more sets of light sources from the array of light sources for indicating the force applied on the brake pedal of the vehicle.

### TECHNICAL FIELD OF THE INVENTION

The invention disclosed herein generally relates to braking systems. More particularly, the invention relates to a braking intensity indication system for indicating a force applied on a brake pedal of a vehicle.

### BACKGROUND

In all traffic scenarios, it is beneficial to indicate the braking intensity of a vehicle based on the force exerted on the brake pedal to a driver of a following vehicle. Consequently, the driver of the following vehicle applies the brake of his/her vehicle based on the indicated intensity to prevent an accident. Conventionally, existing braking intensity indicators require the vehicle's brake lights to be replaced. Replacing a vehicle's existing brake lights is complex as they vary from make and model. For example, new injection molds must be cast to suit the variety of original equipment manufacturer (OEM) designs. Additionally, customizing braking intensity indicators for each varying model raises the production cost translating to a higher cost to the end consumer. A braking intensity indication system, which is simple and installed as an accessory rather than a replacement, is required. Moreover, a braking intensity indication system, which is economic for a consumer, is required.

Furthermore, existing braking indication systems use Hall Effect sensors that act as a variable resistor dependent on the travel distance of the brake pedal. Such sensors are mounted on the brake pedal to indicate the intensity based on the travel distance of the brake pedal. This design has multiple drawbacks as brake pedals of different makes of vehicles are calibrated differently. Moreover, such brake pedals vary in dimension. Additionally, with wear of the braking system, the brake pedal travels further for the same force exerted. This prevents the indication system from correctly indicating the braking intensity. In addition, the Hall Effect sensor varies resistance based on the strength of a magnetic field. Thus, the sensor must be calibrated according to each make and model of brake pedal. The inherent properties of a strengthening and weakening magnetic field require specific and calibrated installation dimensions to maintain standardized information to be transmitted to the microprocessor, which then translates that information to the brake lights. A braking intensity indication system, which requires minimal customization or calibration before installation on a vehicle, is required.

Hence, there is a long felt but unresolved need for a braking intensity indication system, which is simple and installed as an accessory rather than a replacement. Moreover, there is a need for a braking intensity indication system, which is economic for a consumer. Furthermore, there is a need for a braking intensity indication system, which requires minimal customization or calibration before installation on a vehicle.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein, addresses the above-mentioned need for a braking intensity indication system, which is simple and installed as an accessory rather than a replacement. Moreover, the invention addresses the need for a braking intensity indication system, which is economic for a consumer. Furthermore, the invention addresses the need for a braking intensity indication system, which requires minimal customization or calibration before installation on a vehicle. The braking intensity indication system for indicating a force applied on a brake pedal of a vehicle comprises a sensor, a control unit, and an array of light sources. The sensor is mounted on the brake pedal for generating sensor data variables based on the force exerted on the brake pedal. The control unit receives the generated sensor data variables from the sensor. The control unit is configured to analyze the received sensor data variables. The array of light sources is in electrical communication with the control unit. The control unit of the braking intensity indication system actuates one or more sets of light sources from the array of light sources for indicating the force applied on the brake pedal of the vehicle.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a schematic diagram of a braking intensity indication system.

FIG. 2A exemplarily illustrates an electrical circuit diagram of a braking intensity indication system.

FIG. 2B exemplarily illustrates an electrical circuit diagram of a braking intensity indication system.

FIG. 3 exemplarily illustrates a method for indicating a force applied on a brake pedal of a vehicle.

### DETAILED DESCRIPTION OF THE INVENTION

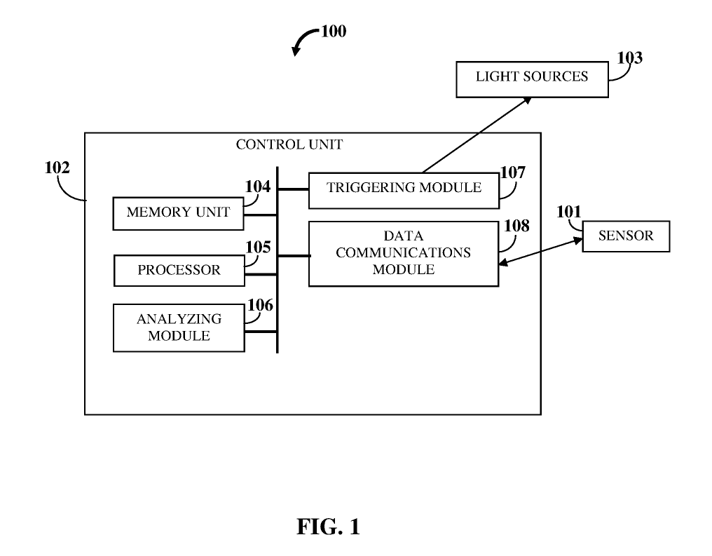

FIG. 1 exemplarily illustrates a schematic diagram of a braking intensity indication system 100. The braking intensity indication system 100 indicates a force applied on a brake pedal of a vehicle comprises a sensor 101, a control unit 102, and an array of light sources 103. The sensor 101 is mounted on the brake pedal for generating sensor data variables based on the force exerted on the brake pedal. The control unit 102 for receiving the generated sensor data variables from the sensor 101. The control unit 102 is configured to analyze the received sensor data variables. The array of light sources 103 is in electrical communication with the control unit 102. The control unit 102 actuates one or more sets of light sources 103 from the array of light sources 103 for indicating the force applied on the brake pedal of the vehicle. The control unit 102, is for example, a micro controller, etc., that is programmed to translate changes in resistance applied to the sensor 101 mounted on the brake pedal. In an embodiment, the sensor 101 is, for example, a force sensitive resistor, etc. The sensor 101 generates sensor data variables, which is subsequently, sent to the control unit 102, for example, the microcontroller.

In an embodiment, the array of light sources 103 is, for example, Adafruit's Neopixel RGB LED strip to indicate from a central section outward the intensity with which a user is stepping on the brake pedal and changing the resistance of the sensor 101, the force sensitive resistor. The control unit 102 of the braking intensity indication system 100 comprises a memory unit 104 configured to store sensor data variables generated by the sensor 101. The control unit 102 further comprises at least one processor 105 communicatively coupled to the memory unit 104. The processor 105 is configured to execute computer program instructions defined by modules of the control unit 102. The processor 105 refers to any one or more microprocessors, central processor (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 105 is implemented as a processor set comprising, for example, a programmed microprocessor and a math or graphics co-processor.

The processor 105 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines) (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The modules of the control unit 102 comprise a data communications module 108, an analyzing module 106, and a triggering module 107. The data communications module 108 is configured to receive the generated sensor data variables from the sensor 101. The analyzing module 106 is configured to dynamically analyze the received sensor data variables and determine the force exerted on the brake pedal. The triggering module 107 is configured to actuate the one or more sets of light sources 103 from the array of light sources 103 for indicating the force applied on the brake pedal of the vehicle. In an embodiment, turn signals are incorporated into the braking intensity indication system 100. For example, when the turn signal is prompted, the array of light sources 103 can have a chasing effect going from the center of the vehicle to the indicated turn side with a pulsating glow. These changes are developed into the braking intensity indication system 100 by re-programming the control unit 102.

The braking intensity indication system 100 disclosed herein is not limited to employing a processor 105. In an embodiment, the braking intensity indication system 100 employs a controller or a microcontroller. The processor 105 executes the modules, for example, 106, 107, 108, etc., of the braking intensity indication system 100. The braking intensity indication system 100 does not interfere with existing standard vehicle lighting. The braking intensity indication system 100 is installed as an addition to standard vehicle lighting and is installed with relative ease to the rear window or bumper of a vehicle using a suction cup or adhesive respectively. In an embodiment, the sensor 101 is mounted in a sleeve or other mounting device attached to the brake pedal surface. The microcontroller of the control unit 102 is installed in a concealed location and the electrical wiring is routed similarly around the vehicle's interior trim. The sensor 101, for example, the force sensitive resistor, mounted on the brake pedal does not require any sophisticated measurements for installation. Therefore, the force sensitive resistor can be installed on any vehicle brake pedal.

The force sensitive resistor varies resistance on force applied, not distance traveled. The braking intensity indication system 100 presents a universal installation rather than requiring specific considerations dependent on a make and a model of vehicle. The braking intensity indication system 100 incorporates a variable resistor (force sensitive resistor) as the primary sensor 101 sensing pressure applied to the brake pedal. The braking intensity indication system 100 does not take into account the travel of the brake pedal. The braking intensity indication system 100 uses one output pin that delivers a signal to the array of light sources 103, for example, the WS2812 Neopixel single wire protocol LED strip. By using the array of light sources 103, the braking intensity indication system 100 is not limited to a discrete number of LED's.

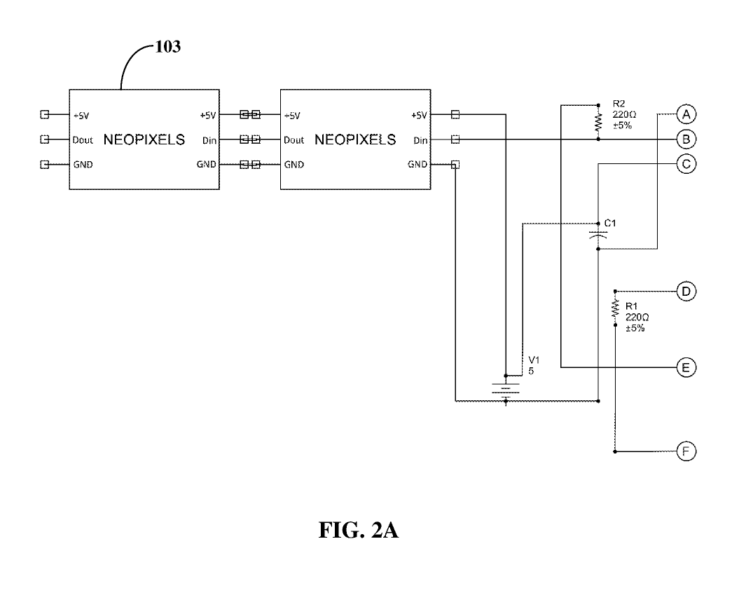

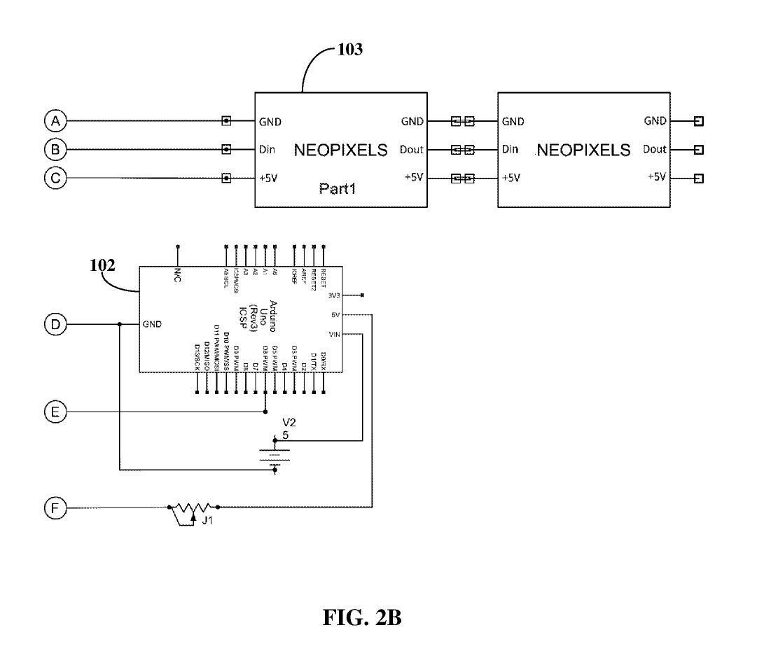

FIGS. 2A-2B exemplarily illustrates an electrical circuit diagram of a braking intensity indication system 100. In an embodiment, the control unit 102 is connected to the array of light sources 103, for example, the WS2812 Neopixel single wire protocol LED strip. In FIGS. 2A-2B, only two LED strips each of the array of light sources 103 are shown, as an example. In an embodiment, the array of light sources 103 includes at least two strips of 30 LEDs each. In an embodiment, a capacitor C1 is connected to the power supply V1 as exemplarily illustrated in FIG. 2A. The capacitor C1 protects the array of light sources 103 from damage when subjected to a power spike or a surge in power supplied by the power supply V1. The control unit 102 actuates the light sources 103 based on the generated sensor data variables received from the sensor 101 as disclosed in the detailed description of FIG. 1. The braking intensity indication system 100 incorporates a variable resistor (force sensitive resistor) as the primary sensor 101 sensing pressure applied to the brake pedal.

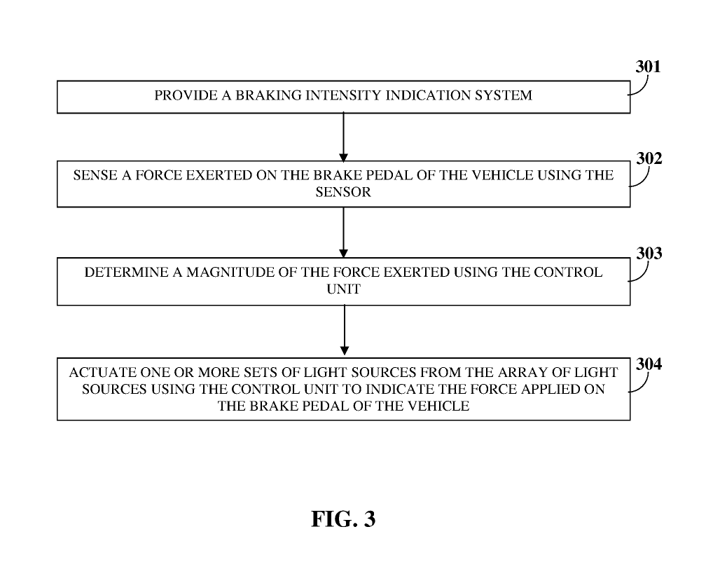

FIG. 3 exemplarily illustrates a method for indicating a force applied on a brake pedal of a vehicle. In the method disclosed herein, a braking intensity indication system 100 comprising a sensor 101 mounted on the brake pedal, a control unit 102, and an array of light sources 103, is provided 301. A force exerted on the brake pedal of the vehicle by the user is sensed 302 by the sensor 101, for example, the force sensitive resistor. The magnitude of the force exerted is determined 303 by the control unit 102. The one or more sets of light sources 103 from the array of light sources 103 is actuated 304 by the control unit 102 for indicating the force applied on the brake pedal of the vehicle.

The foregoing examples have been provided merely for the purpose of explanation and are in no way to be construed as limiting of the braking intensity indication system 100, disclosed herein. While the braking intensity indication system 100 has been described with reference to various embodiments, it is understood that the words, which have been used herein, are words of description and illustration, rather than words of limitation. Further, although the braking intensity indication system 100, has been described herein with reference to particular means, materials, and embodiments, the braking intensity indication system 100 is not intended to be limited to the particulars disclosed herein; rather, the braking intensity indication system 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the braking intensity indication system 100 disclosed herein in their aspects.

1. A braking intensity indication system for indicating a force applied on a brake pedal of a vehicle, the braking intensity indication system comprising:
a non-magnet sensor mounted on the brake pedal for generating force data variables of the force exerted on the brake pedal;
a control unit for receiving the generated force data variables from the sensor, wherein the control unit is configured to analyze the received force sensor data variables; and
an array of light sources in electrical communication with the control unit, wherein the control unit actuates one or more sets of light sources from the array of light sources indicating the force applied on the brake pedal of the vehicle.

2. The braking intensity indication system of claim 1, wherein the sensor is a force resistive sensor.

3. The braking intensity indication system of claim 1, wherein the control unit is a microcontroller.

4. The braking intensity indication system of claim 1, wherein the light sources are LED lights.

5. The braking intensity indication system of claim 1, wherein the control unit comprises:
a non-transitory computer readable storage medium configured to store sensor data variables generated by the sensor; and
at least one processor communicatively coupled to the non-transitory computer readable storage medium, the at least one processor configured to execute computer program instructions defined by modules of the control unit, the modules of the control unit comprising:
a data communications module configured to receive the generated sensor data variables from the sensor;
an analyzing module configured to dynamically analyze the received sensor data variables and determine the force exerted on the brake pedal; and
a triggering module configured to actuate the one or more sets of light sources from the array of light sources for indicating the force applied on the brake pedal of the vehicle.

6. A method for indicating a force applied on a brake pedal of a vehicle, the method comprising:
providing a braking intensity indication system comprising:
a non-magnet force sensor mounted on the brake pedal;
a control unit for receiving generated sensor data variables of force from the force sensor; and
an array of light sources in electrical communication with the control unit;
sensing a force exerted on the brake pedal of the vehicle by the force sensor;
determining a magnitude of the force exerted using the control unit; and
actuating one or more sets of light sources from the array of light sources by the control unit indicating the force applied on the brake pedal of the vehicle.

7. The method of claim 1, wherein the sensor is a force resistive sensor.

8. The method of claim 1, wherein the control unit is a microcontroller.

9. The method of claim 1, wherein the light sources are LED lights.
